(19) United States
(12) Patent Application Publication
(10) Pub. No.: US 2026/0081699 A1
(43) Pub. Date: Mar. 19, 2026

(54) INGRESS CANCELLATION

(71) Applicant: Cox Communications, Inc., Atlanta, GA (US)

(72) Inventors: William Wall, Atlanta, GA (US); Keith Alan Rothschild, Atlanta, GA (US)

(73) Assignee: Cox Communications, Inc., Atlanta, GA (US)

(21) Appl. No.: 18/888,783

(22) Filed: Sep. 18, 2024

(51) Int. Cl. H04B 15/00

(52) U.S. Cl. CPC H04B 15/00

(57) ABSTRACT

Ingress cancellation may be provided. A computing device may determine an Over-the-Air (OTA) signal. Next, the computing device may create a composite cancelation signal based on the OTA signal. The composite cancelation signal may be configured to cancel ingress noise created by the OTA signal. Then the computing device may combine the composite cancelation signal with a real-time upstream signal.

### TECHNICAL FIELD

The present disclosure relates generally to providing ingress cancellation.

### BACKGROUND

Cable television is a system of providing television to consumers via signals transmitted to a television set through fixed optical fibers or coaxial cables. A Set-Top Box (STB) may be used to convert the cable television signals to ones usable by a television set. The cable television system may utilize a Hybrid Fiber-Coaxial (HFC) network, that comprises a broadband network that combines optical fiber and coaxial cable. In the HFC network, television channels may be sent from a cable system's distribution facility to local communities through optical fiber trunk lines. At the local community, a box translates the signal from a light beam to electrical signal, and sends it over cable lines for distribution to subscriber residences. The optical fiber trunk lines may provide adequate bandwidth to allow future expansion and new bandwidth-intensive services.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing ingress cancellation;

FIG. 2 is a flow chart of a method for providing ingress cancellation; and

FIG. 3 is a block diagram of a computing device.

### DETAILED DESCRIPTION

### Overview

Ingress cancellation may be provided. A computing device may determine an Over-the-Air (OTA) signal. Next, the computing device may create a composite cancelation signal based on the OTA signal. The composite cancelation signal may be configured to cancel ingress noise created by the OTA signal. Then the computing device may combine the composite cancelation signal with a real-time upstream signal.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Multiple-system operators (MSOs) are operators of multiple cable or direct-broadcast satellite television systems. These systems may include HFC networks that may be Data Over Cable Service Interface Specification (DOCSIS) compliant. To amplify upstream (US) signals and downstream (DS) signals in the HFC network, MSOs may use nodes deployed within the HFC. In the HFC network, a node may comprise a container that may house optical and electrical circuitry. An optical fiber cable or a coaxial cable may be connected to an input side of the node and a plurality of coaxial cables may be connected to a output side of the node. The input side of the node may be connect to a headend in the HFC network and the DS side of the node may be connected to Customer Premises Equipment (CPE) of subscribers to the HFC.

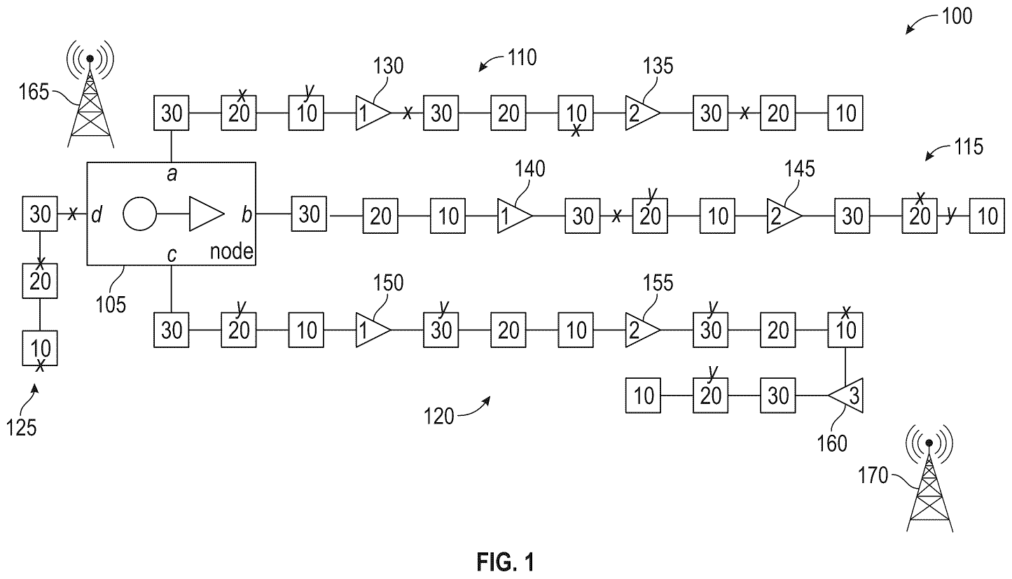

FIG. 1 shows an operating environment 100 for providing ingress cancellation. As shown in FIG. 1, operating environment 100 may comprise a cable television plant (e.g., an HFC). The cable television plant may comprise a node 105 and a plurality of legs. The plurality of legs may comprise a first leg 110, a second leg 115, a third leg 120, and a fourth leg 125. The plurality of legs may comprise taps and amplifiers. Taps may connect CPE of subscribers to the HFC via drops. Amplifiers may amplify US signals and DS signals on the legs.

In first leg 110, three taps may exist between node 105 and a first leg first amplifier 130, three taps may exist between first leg first amplifier 130 and a first leg second amplifier 135, and three taps may exist after first leg second amplifier 135. In second leg 115, three taps may exist between node 105 and a second leg first amplifier 140, three taps may exist between second leg first amplifier 140 and a second leg second amplifier 145, and three taps may exist after second leg second amplifier 145. In third leg 120, three taps may exist between node 105 and a third leg first amplifier 150, three taps may exist between third leg first amplifier 150 and a third leg second amplifier 155, three taps may exist between third leg second amplifier 155 and a third leg third amplifier 160, and three taps may exist after third leg third amplifier 160. Fourth leg 125 may comprise three taps.

Over-the-Air (OTA) signals may cause ingress noise on operating environment 100 (e.g., the cable plant). As shown in FIG. 1, these OTA signals may be emitted from a first OTA signal source 165 and a second OTA signal source 170. The ingress noise may be created by other sources. First OTA signal source 165 and second OTA signal source 170 may comprise, but are not limited to, a Frequency Modulation (FM) radio signal or a Television (TV) signal for example. Notwithstanding, first OTA signal source 165 and second OTA signal source 170 may comprise any aerially transmitted signals, for example, in the spectrum/frequency range of radio and/or television signals.

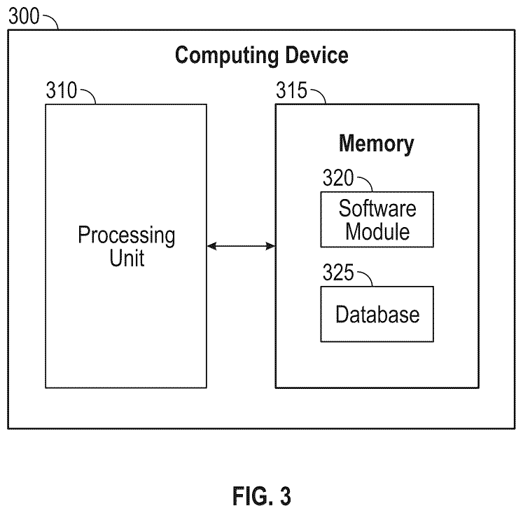

The elements described above of operating environment 100 (e.g., node 105, first leg first amplifier 130, first leg second amplifier 135, second leg first amplifier 140, second leg second amplifier 145, third leg first amplifier 150, third leg second amplifier 155, and third leg third amplifier 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

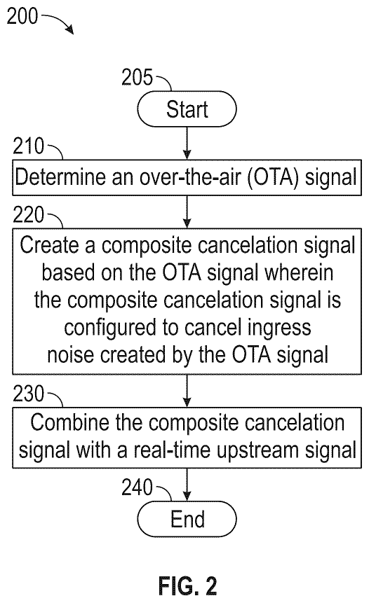

FIG. 2 is a flow chart setting forth the general stages involved in a method 200 consistent with embodiments of the disclosure for providing ingress cancellation. Method 200 may be implemented using a computing device 300 as described in more detail below with respect to FIG. 3. Computing device 300, for example, may be embodied by node 105 or any of the amplifiers described in FIG. 1. Ways to implement the stages of method 200 will be described in greater detail below.

Method 200 may begin at starting block 205 and proceed to stage 210 where computing device 300 may determine an Over-the-Air (OTA) signal. For example, an antenna may be used to receive signals in the area of operating environment 100 to detect signals that may tend to interfere with operating environment 100. First OTA signal source 165 and second OTA signal source 170 may produce signals that may tend to interfere with operating environment 100. These signals may be provided to computing device 300.

As shown in FIG. 1, operating environment 100 may comprise a plurality of ingress points. First OTA signal source 165 and second OTA signal source 170 may produce signals that may tend to enter operating environment 100 at the plurality of ingress points. By entering operating environment 100 at the plurality of ingress points, first OTA signal source 165 and second OTA signal source 170 may introduce ingress noise on operating environment 100. As shown by FIG. 1, an “x” may illustrate an ingress point at which at which first OTA signal source 165 may introduce ingress noise on operating environment 100. Similarly, a “y” may illustrate an ingress point at which at which second OTA signal source 170 may introduce ingress noise on operating environment 100.

Ingress points closer to an OTA signal source may be likely to have ingress noise at higher power amplitude levels than ones further away from the OTA signal source. Furthermore, ingress points further from node 105 may be more likely to produce ingress noise with a higher time delay than ones closer to node 105. Also, ones of the plurality of ingress points may by in CPE or on the cable plant itself and may comprise, but are not limited to, open wires, loose connections, or plant damage caused by rodents for example.

From stage 210, where computing device 300 determines the OTA signal, method 200 may advance to stage 220 where computing device 300 may create a composite cancelation signal based on the OTA signal. The composite cancelation signal may be configured to cancel ingress noise created by the OTA signal (e.g., from one or both of first OTA signal source 165 and second OTA signal source 170). For example, operating environment 100 may include unwanted ingress noise caused by the OTA signal (or signals) introduced onto operating environment 100 at the plurality of ingress points. Embodiments of the disclosure may time-slice each of the OTA signals identified. Next, an amplification factor may be determined for each time-slice for each OTA source. Then an inverse composite signal (i.e., ingress cancellation signal) may be created. In other words, for each ingress point and OTA signal source, a version of the OTA signal that infiltrates operating environment 100 at each given ingress point having an inverse magnitude and time delay to node 105 may be created. The composite cancelation signal may comprise a composite of each of these versions.

Once computing device 300 creates the composite cancelation signal based on the OTA signal in stage 220, method 200 may continue to stage 230 where computing device 300 may combine the composite cancelation signal with a real-time upstream signal. For example, the real-time upstream signal may be propagating from CPE on the drops to the taps through the amplifiers to node 105. This real-time upstream signal may include unwanted ingress noise introduced onto the real-time upstream signal at the various ingress points. Combining the composite cancelation signal with the real-time upstream signal at node 105 may tend to cancel out the unwanted ingress noise at node 105. In this way node 105 may further propagate the real-time upstream signal up the system in a way that may lessen or eliminate ingress noise that may have been introduced at the various ingress points. Once computing device 300 combines the composite cancelation signal with the real-time upstream signal in stage 230, method 200 may then end at stage 240.

An embodiment consistent with the disclosure may comprise a method for providing ingress cancellation. The method may comprise determining an Over-the-Air (OTA) signal; creating a composite cancelation signal based on the OTA signal wherein the composite cancelation signal is configured to cancel ingress noise created by the OTA signal; and combining the composite cancelation signal with a real-time upstream signal.

Another embodiment consistent with the disclosure may comprise a system for providing ingress cancellation. The system may comprise a memory storage and a processing unit coupled to the memory storage. The processing unit may be operative to: determine an Over-the-Air (OTA) signal; create a composite cancelation signal based on the OTA signal wherein the composite cancelation signal is configured to cancel ingress noise created by the OTA signal; and combine the composite cancelation signal with a real-time upstream signal.

Yet another embodiment consistent with the disclosure may comprise a a non-transitory computer-readable medium that stores a set of instructions which when executed perform a method executed by the set of instructions. The set of instructions may comprise determining an Over-the-Air (OTA) signal; creating a composite cancelation signal based on the OTA signal wherein the composite cancelation signal is configured to cancel ingress noise created by the OTA signal; and combining the composite cancelation signal with a real-time upstream signal.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing ingress cancellation as described above with respect to FIG. 2. Computing device 300, for example, may provide an operating environment for node 105, first leg first amplifier 130, first leg second amplifier 135, second leg first amplifier 140, second leg second amplifier 145, third leg first amplifier 150, third leg second amplifier 155, or third leg third amplifier 160. Node 105, first leg first amplifier 130, first leg second amplifier 135, second leg first amplifier 140, second leg second amplifier 145, third leg first amplifier 150, third leg second amplifier 155, and third leg third amplifier 160 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining an Over-the-Air (OTA) signal;
creating a composite cancelation signal based on the OTA signal wherein the composite cancelation signal is configured to cancel ingress noise created by the OTA signal; and
combining the composite cancelation signal with a real-time upstream signal.

2. The method of claim 1, wherein the ingress noise is created by the OTA signal at least one point in a plant.

3. The method of claim 2, wherein the plant comprises a cable television plant.

4. The method of claim 2, wherein creating the composite cancelation signal based on the OTA signal comprises creating the composite cancelation signal having a magnitude and timing configured to cancel the ingress noise.

5. The method of claim 1, wherein creating the composite cancelation signal comprises creating the composite cancelation signal at a node.

6. The method of claim 1, wherein creating the composite cancelation signal comprises creating the composite cancelation signal at an amplifier.

7. The method of claim 1, wherein the OTA signal comprises a Frequency Modulation (FM) radio signal.

8. The method of claim 1, wherein the OTA signal comprises a Television (TV) radio signal.

9. A system comprising:
a memory storage; and
a processing unit coupled to the memory storage, wherein the processing unit is operative to:
determine an Over-the-Air (OTA) signal;
create a composite cancelation signal based on the OTA signal wherein the composite cancelation signal is configured to cancel ingress noise created by the OTA signal; and
combine the composite cancelation signal with a real-time upstream signal.

10. The system of claim 9, wherein the ingress noise is created by the OTA signal at at least one point in a plant.

11. The system of claim 10, wherein the plant comprises a cable television plant.

12. The system of claim 10, wherein the processing unit being operative to create the composite cancelation signal based on the OTA signal comprises the processing unit being operative to create the composite cancelation signal having a magnitude and timing configured to cancel the ingress noise.

13. A non-transitory computer-readable medium that stores a set of instructions which when executed perform a method executed by the set of instructions comprising:
determining an Over-the-Air (OTA) signal;
creating a composite cancelation signal based on the OTA signal wherein the composite cancelation signal is configured to cancel ingress noise created by the OTA signal; and
combining the composite cancelation signal with a real-time upstream signal.

14. The non-transitory computer-readable medium of claim 13, wherein the ingress noise is created by the OTA signal at at least one point in a plant.

15. The non-transitory computer-readable medium of claim 14, wherein the plant comprises a cable television plant.

16. The non-transitory computer-readable medium of claim 14, wherein creating the composite cancelation signal based on the OTA signal comprises creating the composite cancelation signal having a magnitude and timing configured to cancel the ingress noise.

17. The non-transitory computer-readable medium of claim 13, wherein creating the composite cancelation signal comprises creating the composite cancelation signal at a node.

18. The non-transitory computer-readable medium of claim 13, wherein creating the composite cancelation signal comprises creating the composite cancelation signal at an amplifier.

19. The non-transitory computer-readable medium of claim 13, wherein the OTA signal comprises a Frequency Modulation (FM) radio signal.

20. The non-transitory computer-readable medium of claim 13, wherein the OTA signal comprises a Television (TV) radio signal.
